(19) United States
(12) Patent Application Publication
(10) Pub. No.: US 2022/0065669 A1
(43) Pub. Date: Mar. 3, 2022

(54) METHOD AND SYSTEM FOR DETECTING EVENTS IN A CONDUIT

(71) Applicant: Hifi Engineering Inc., Calgary, Alberta (CA)

(72) Inventors: Arne Dankers, Calgary, Alberta (CA); Seyed Ehsan Jalilian, Calgary, Alberta (CA)

(21) Appl. No.: 17/298,942

(22) PCT Filed: Dec. 2, 2019
(86) PCT No.: PCT/CA2019/051729

§ 371 Date: Jun. 1, 2021

Related U.S. Application Data
(60) Provisional application No. 62/774,632, filed on Dec. 3, 2018.

(51) Int. Cl. G01D 5/353; G01M 3/02; F17D 5/06

(52) U.S. Cl. CPC G01D 5/35306; F17D 5/06; G01M 3/02

(57) ABSTRACT

There are described methods, systems, and computer-readable media for detecting events in a conduit. A first length of optical fiber, positioned alongside the conduit, is interrogated to obtain interferometric data from the first length of optical fiber. A second length of optical fiber, positioned alongside the conduit, is interrogated to obtain interferometric data from the second length of optical fiber. The interferometric data obtained from the first length of optical fiber is compared with the interferometric data obtained with the second length of optical fiber. Based on the comparison, whether an event has occurred in the conduit is determined.

### FIELD OF THE DISCLOSURE

The present disclosure relates to methods and systems for detecting events, such as leaks, in a conduit, such as a pipeline or a wellbore.

### BACKGROUND TO THE DISCLOSURE

Fiber optic cables are often used for distributed measurement systems in acoustic sensing applications. Pressure changes, due to sound waves for example, in the space immediately surrounding an optical fiber and that encounter the optical fiber cause dynamic strain in the optical fiber. Optical interferometry may be used to detect the dynamic strain along a segment of the fiber. Optical interferometry is a technique in which two separate light pulses, a sensing pulse and a reference pulse, are generated and interfere with each other. The sensing and reference pulses may, for example, be directed along an optical fiber that comprises fiber Bragg gratings. The fiber Bragg gratings partially reflect the pulses back towards an optical receiver at which an interference pattern is observed.

The nature of the interference pattern observed at the optical receiver provides information on the optical path length the pulses traveled, which in turn provides information on parameters such as the strain experienced by the segment of optical fiber between the fiber Bragg gratings. Information on the strain then provides information about the event that caused the strain.

It is important with optical fiber interferometry to reduce the occurrence of false positives. False positives are events that can be caused by either real ambient conditions or by system noise. In both cases, the processing algorithms may falsely identify an event where an event of interest in fact has not occurred. Examples of false positives due to real ambient conditions may include mistaking rain for a pipeline leak, or mistaking a noise spike in the system for an intrusion event. In a fiber optic system, various causes of system noise may include electrical noise (caused by 60 Hz power harmonics coupling onto optical measurements), vibrations near the interrogator affecting the measurement, laser noise, optical fading, micro-movements of the optical fiber being interpreted as major strain events, and speckle noise.

Current methods of detecting system noise in fiber optic applications are based on identifying characteristics of the noise, for example by tracking and removing common mode events. Erratic strain (which may be caused by localized micro-movements of the fiber optic sensor or by optical fading) can sometimes be detected by analyzing its signature, such as broadband frequency content with a very large magnitude. Overall, detecting system noise remains challenging as there exist multiple sources of such noise, and its signature can often resemble that of real data. Thus, the risk of detecting false positives remains relatively high.

### SUMMARY OF THE DISCLOSURE

In a first aspect of the disclosure, there is provided a method of detecting events in a conduit, comprising: interrogating a first length of optical fiber, positioned alongside the conduit, to obtain interferometric data from the first length of optical fiber; interrogating a second length of optical fiber, positioned alongside the conduit, to obtain interferometric data from the second length of optical fiber; comparing the interferometric data obtained from the first length of optical fiber with the interferometric data obtained from the second length of optical fiber; and determining, based on the comparison, whether an event has occurred in the conduit.

Interrogating the first length of optical fiber may comprise obtaining interferometric data from each of multiple channels of the first length of optical fiber, each channel comprising a portion of the first length of optical fiber. Interrogating the second length of optical fiber may comprise obtaining interferometric data from each of multiple channels of the second length of optical fiber, each channel comprising a portion of the second length of optical fiber. Comparing the interferometric data may comprise, for at least a first channel of the first length of optical fiber and a corresponding second channel of the second length of optical fiber, comparing their respective interferometric data, wherein, from among the channels of the second length of optical fiber, the second channel is the channel closest to the first channel. Thus, the location of an event, such as a leak, in a conduit may be identified as a function of the channels of the lengths of optical fiber.

The first and second lengths of optical fiber may be positioned within five meters of one another.

Each channel of one of the lengths of optical fiber may be positioned alongside a corresponding channel of the other length of optical fiber.

Interrogating the lengths of optical fiber may comprise: using an optical fiber interrogator to: transmit one or more light pulses along each of the first and second lengths of optical fiber; and receive reflections of the one or more light pulses from each of the first and second lengths of optical fiber; and obtaining the interferometric data from interferences between the reflections.

The conduit may comprise a pipeline or a wellbore.

Comparing the interferometric data may comprise: for each of the lengths of optical fiber, extracting parameter data from the interferometric data obtained from the length of optical fiber; and comparing the parameter data obtained from the first length of optical fiber with the parameter data obtained from the second length of optical fiber.

The interferometric data may be representative of one or more of an acoustic signal, a strain signal, and a temperature signal. The parameter data may comprise one or more of: a magnitude of the signal, a frequency centroid of the signal, a filtered baseline of the signal, a harmonic power of the signal, and a time-integrated spectrum flux of the signal. The disclosure extends to other types of parameter data.

Determining whether an event has occurred may comprise determining whether a difference between a magnitude of the parameter data obtained from the first length of optical fiber and a magnitude of the parameter data obtained from the second length of optical fiber is less than a preset threshold.

Determining whether an event has occurred may comprise determining whether a cross-correlation strength of the parameter data obtained from the first length of optical fiber with the parameter data obtained from the second length of optical fiber is greater than a preset threshold. Cross-correlation between two measured parameters generally produces two outputs: one is the cross-correlation strength, and the other is the lag (delta t). The closer the two parameters are to each other in shape (e.g. two parameters recorded using different sensors but resulting from the same event), the greater the cross-correlation strength.

The first length of optical fiber may be closer to the conduit than the second length of optical fiber.

The interferometric data may comprise one or more of acoustic data, strain data, and temperature data.

Comparing the interferometric data may comprise, for each of the lengths of optical fiber, extracting parameter data from the interferometric data obtained from the length of optical fiber; determining from the extracted parameter data whether a potential event has occurred in the conduit; and comparing a potential event obtained from the first length of optical fiber with a potential event obtained from the second length of optical fiber to thereby determine, based on the comparison, whether an event has occurred in the conduit.

In a further aspect of the disclosure, there is provided a system for detecting events in a conduit, comprising: a conduit; first and second lengths of optical fiber positioned alongside the conduit; an optical fiber interrogator configured to: interrogate the first length of optical fiber so as to obtain interferometric data therefrom; and interrogate the second length of optical fiber so as to obtain interferometric data therefrom; and one or more processors communicative with a memory having stored thereon computer program code configured when executed by the one or more processors to cause the one or more processors to perform a method comprising: comparing the interferometric data obtained from the first length of optical fiber with the interferometric data obtained from the second length of optical fiber; and determining, based on the comparison, whether an event has occurred in the conduit.

The system may comprise any of the features described above in connection with the first aspect of the disclosure.

In a further aspect of the disclosure, there is provided a computer-readable medium having stored thereon computer program code configured when executed by one or more processors to cause the one or more processors to perform a method comprising: obtaining interferometric data from a first length of optical fiber, wherein the first length of optical fiber is positioned alongside a conduit; obtaining interferometric data from a second length of optical fiber, wherein the second length of optical fiber is positioned alongside the conduit; comparing the interferometric data obtained from the first length of optical fiber with the interferometric data obtained from the second length of optical fiber; and determining, based on the comparison, whether an event has occurred in the conduit.

The computer-readable medium may comprise any of the features described above in connection with the first aspect of the disclosure.

### BRIEF DESCRIPTION OF THE DRAWINGS

Embodiments of the disclosure will now be described in detail in conjunction with the accompanying drawings of which:

FIG. 1A is a block diagram of a system for determining whether an event has occurred from dynamic strain measurements, which includes an optical fiber with fiber Bragg gratings (“FBGs”) for reflecting a light pulse, in accordance with an embodiment of the disclosure;

FIG. 1B is a schematic diagram that depicts how the FBGs reflect a light pulse;

FIG. 10 is a schematic diagram that depicts how a light pulse interacts with impurities in an optical fiber that results in scattered laser light due to Rayleigh scattering, which is used for distributed acoustic sensing (“DAS”);

FIG. 2 is a schematic diagram of an optical interrogation system in accordance with an embodiment of the disclosure;

FIG. 3 is a schematic diagram of an optical interrogation system in accordance with another embodiment of the disclosure; and

FIG. 4 is a flow diagram of a method of detecting events in a conduit, in accordance with an embodiment of the disclosure.

### DETAILED DESCRIPTION OF EMBODIMENTS

The present disclosure seeks to provide improved methods and systems for detecting events in a conduit. While various embodiments of the disclosure are described below, the disclosure is not limited to these embodiments, and variations of these embodiments may well fall within the scope of the disclosure which is to be limited only by the appended claims.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

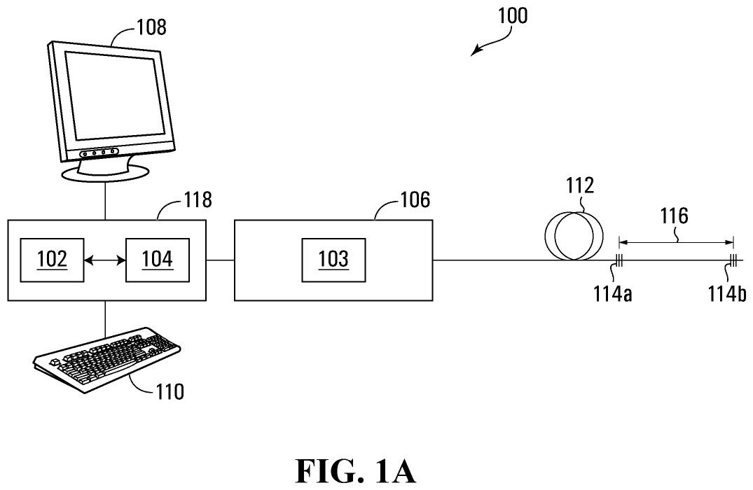

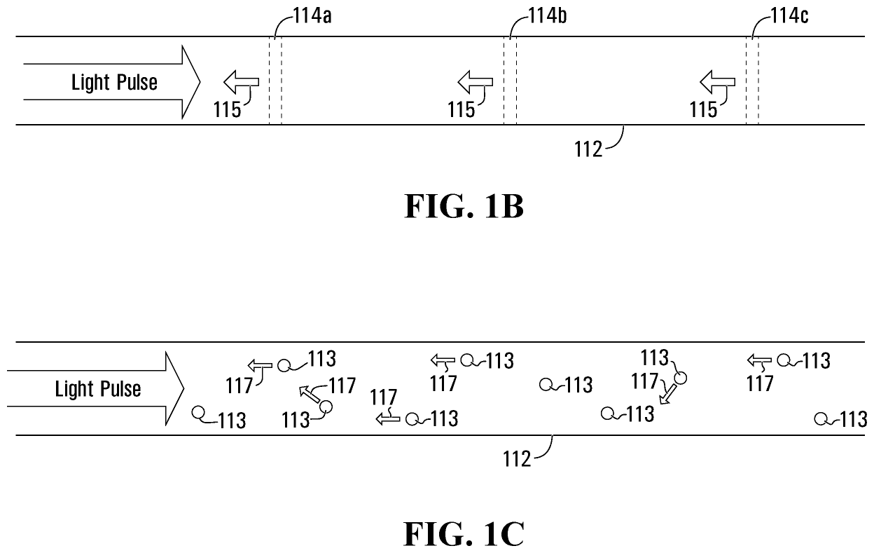

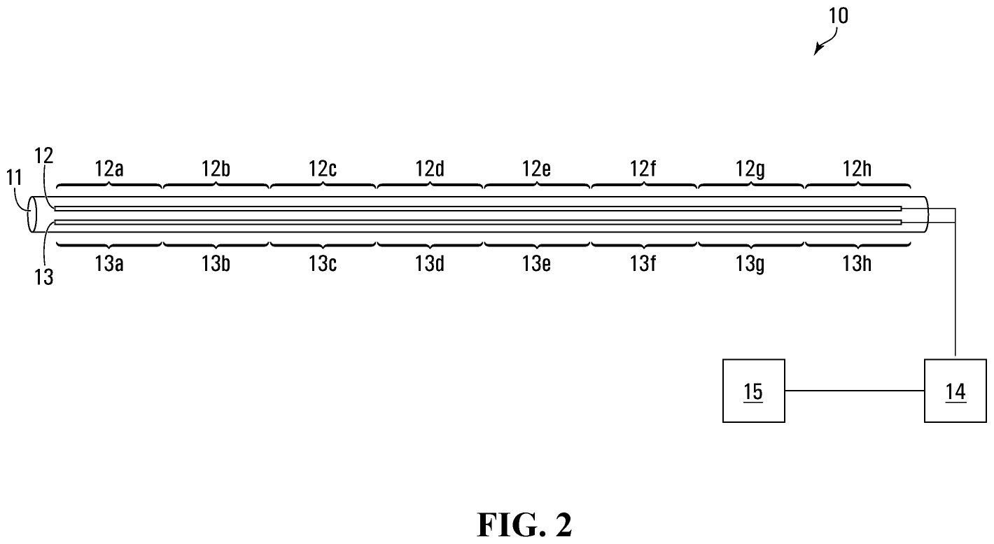

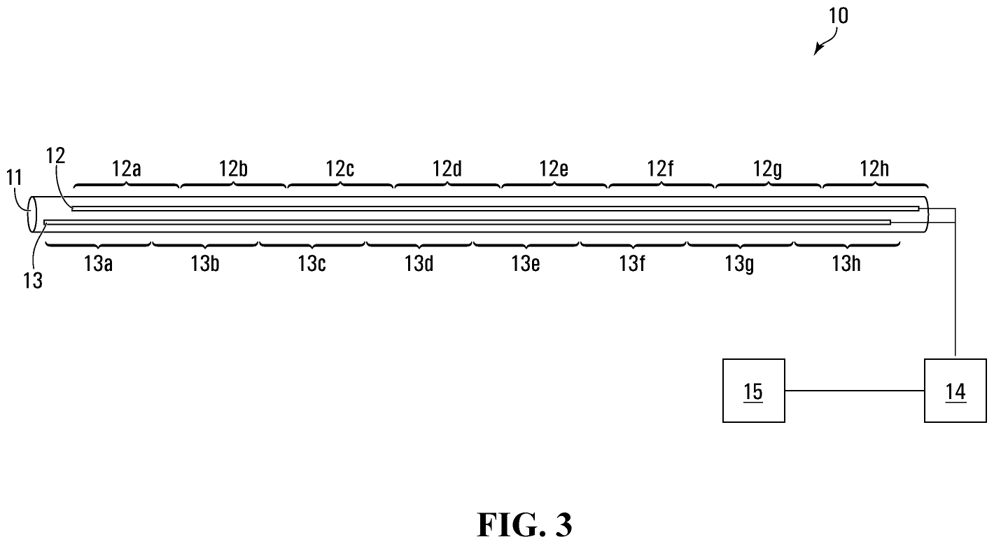

Referring now to FIG. 1A, there is shown one embodiment of a system 100 for performing interferometry using fiber Bragg gratings (“FBGs”). The system 100 comprises optical fiber 112, an interrogator 106 optically coupled to the optical fiber 112, and a signal processing device 118 that is communicative with the interrogator 106.

The optical fiber 112 comprises one or more fiber optic strands, each of which is made from quartz glass (amorphous SiO2). The fiber optic strands are doped with various elements and compounds (including germanium, erbium oxides, and others) to alter their refractive indices, although in alternative embodiments the fiber optic strands may not be doped. Single mode and multimode optical strands of fiber are commercially available from, for example, Corning® Optical Fiber. Example optical fibers include ClearCurve™ fibers (bend insensitive), SMF28 series single mode fibers such as SMF-28 ULL fibers or SMF-28e fibers, and InfmiCor® series multimode fibers.

The interrogator 106 generates the sensing and reference pulses and outputs the reference pulse after the sensing pulse. The pulses are transmitted along optical fiber 112 that comprises a first pair of FBGs. The first pair of FBGs comprises first and second FBGs 114a,b (generally, “FBGs 114”). The first and second FBGs 114a,b are separated by a certain segment 116 of the optical fiber 112 (“fiber segment 116”). The optical length of the fiber segment 116 varies in response to dynamic strain that the fiber segment 116 experiences.

The light pulses have a wavelength identical or very close to the center wavelength of the FBGs 114, which is the wavelength of light the FBGs 114 are designed to partially reflect; for example, typical FBGs 114 are tuned to reflect light in the 1,000 to 2,000 nm wavelength range. The sensing and reference pulses are accordingly each partially reflected by the FBGs 114a,b and return to the interrogator 106. The delay between transmission of the sensing and reference pulses is such that the reference pulse that reflects off the first FBG 114a (hereinafter the “reflected reference pulse”) arrives at the optical receiver 103 simultaneously with the sensing pulse that reflects off the second FBG 114b (hereinafter the “reflected sensing pulse”), which permits optical interference to occur.

While FIG. 1A shows only the one pair of FBGs 114a,b, in alternative embodiments (not depicted) any number of FBGs 114 may be on the fiber 112, and time division multiplexing (TDM) (and, optionally, wavelength division multiplexing (WDM)) may be used to simultaneously obtain measurements from them. If two or more pairs of FBGs 114 are used, any one of the pairs may be tuned to reflect a different center wavelength than any other of the pairs. Alternatively, a group of multiple FBGs 114 may be tuned to reflect a different center wavelength to another group of multiple FBGs 114, and there may be any number of groups of multiple FBGs extending along the optical fiber 112 with each group of FBGs 114 tuned to reflect a different center wavelength. In these example embodiments where different pairs or group of FBGs 114 are tuned to reflect different center wavelengths to other pairs or groups of FBGs 114, WDM may be used in order to transmit and to receive light from the different pairs or groups of FBGs 114, effectively extending the number of FBG pairs or groups that can be used in series along the optical fiber 112 by reducing the effect of optical loss that otherwise would have resulted from light reflecting from the FBGs 114 located on the fiber 112 nearer to the interrogator 106. When different pairs of the FBGs 114 are not tuned to different center wavelengths, TDM is sufficient.

The interrogator 106 emits laser light with a wavelength selected to be identical or sufficiently near the center wavelength of the FBGs 114, and each of the FBGs 114 partially reflects the light back towards the interrogator 106. The timing of the successively transmitted light pulses is such that the light pulses reflected by the first and second FBGs 114a,b interfere with each other at the interrogator 106, which records the resulting interference signal. The strain that the fiber segment 116 experiences alters the optical path length between the two FBGs 114 and thus causes a phase difference to arise between the two interfering pulses. The resultant optical power at the optical receiver 103 can be used to determine this phase difference. Consequently, the interference signal that the interrogator 106 receives varies with the strain the fiber segment 116 is experiencing, which allows the interrogator 106 to estimate the strain the fiber segment 116 experiences from the received optical power. The interrogator 106 digitizes the phase difference (“output signal”) whose magnitude and frequency vary directly with the magnitude and frequency of the dynamic strain the fiber segment 116 experiences.

The signal processing device 118 is communicatively coupled to the interrogator 106 to receive the output signal. The signal processing device 118 includes a processor 102 and a non-transitory computer-readable medium 104 that are communicatively coupled to each other. An input device 110 and a display 108 interact with control module 250. The computer-readable medium 104 has stored on it program code to cause control module 250 to perform any suitable signal processing methods to the output signal. For example, if the fiber segment 116 is laid adjacent a region of interest that is simultaneously experiencing vibration at a rate under 20 Hz and acoustics at a rate over 20 Hz, the fiber segment 116 will experience similar strain and the output signal will comprise a superposition of signals representative of that vibration and those acoustics. Control module 250 may apply to the output signal a low pass filter with a cut-off frequency of 20 Hz, to isolate the vibration portion of the output signal from the acoustics portion of the output signal. Analogously, to isolate the acoustics portion of the output signal from the vibration portion, control module 250 may apply a high-pass filter with a cut-off frequency of 20 Hz. Control module 250 may also apply more complex signal processing methods to the output signal; example methods include those described in PCT application PCT/CA2012/000018 (publication number WO 2013/102252), the entirety of which is hereby incorporated by reference.

FIG. 1B depicts how the FBGs 114 reflect the light pulse, according to another embodiment in which the optical fiber 112 comprises a third FBG 114c. In FIG. 1B, the second FBG 114b is equidistant from each of the first and third FBGs 114a,c when the fiber 112 is not strained. The light pulse is propagating along the fiber 112 and encounters three different FBGs 114, with each of the FBGs 114 reflecting a portion 115 of the pulse back towards the interrogator 106. In embodiments comprising three or more FBGs 114, the portions of the sensing and reference pulses not reflected by the first and second FBGs 114a,b can reflect off the third FBG 114c and any subsequent FBGs 114, resulting in interferometry that can be used to detect strain along the fiber 112 occurring further from the interrogator 106 than the second FBG 114b. For example, in the embodiment of FIG. 1B, a portion of the sensing pulse not reflected by the first and second FBGs 114a,b can reflect off the third FBG 114c, and a portion of the reference pulse not reflected by the first FBG 114a can reflect off the second FBG 114b, and these reflected pulses can interfere with each other at the interrogator 106.

Any changes to the optical path length of the fiber segment 116 result in a corresponding phase difference between the reflected reference and sensing pulses at the interrogator 106. Since the two reflected pulses are received as one combined interference pulse, the phase difference between them is embedded in the combined signal. This phase information can be extracted using proper signal processing techniques, such as phase demodulation. The relationship between the optical path of the fiber segment 116 and that phase difference (Θ) is as follows:

θ=2πnL/λ,

where n is the index of refraction of the optical fiber, L is the physical path length of the fiber segment 116, and λ is the wavelength of the optical pulses. A change in nL is caused by the fiber experiencing longitudinal strain induced by energy being transferred into the fiber. The source of this energy may be, for example, an object outside of the fiber experiencing dynamic strain, undergoing vibration, or emitting energy. As used herein, “dynamic strain” refers to strain that changes over time. Dynamic strain that has a frequency of between about 5 Hz and about 20 Hz is referred to by persons skilled in the art as “vibration”, dynamic strain that has a frequency of greater than about 20 Hz is referred to by persons skilled in the art as “acoustics”, and dynamic strain that changes at a rate of <1 Hz, such as at 500 μHz, is referred to as “sub-Hz strain”.

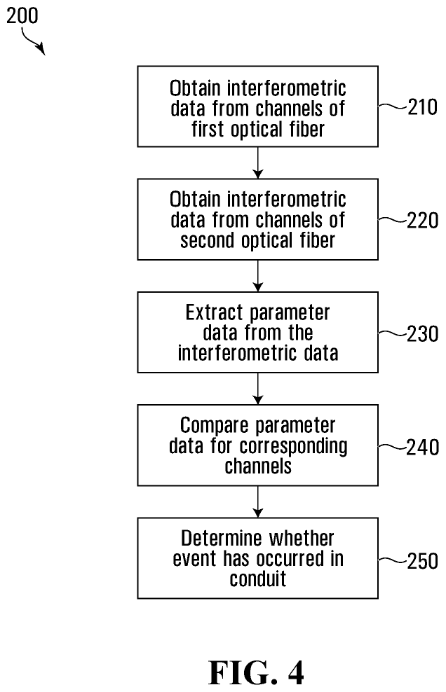

One conventional way of determining ΔnL is by using what is broadly referred to as distributed acoustic sensing (“DAS”). DAS involves laying the fiber 112 through or near a region of interest and then sending a coherent laser pulse along the fiber 112. As shown in FIG. 10, the laser pulse interacts with impurities 113 in the fiber 112, which results in scattered laser light 117 because of Rayleigh scattering. Vibration or acoustics emanating from the region of interest results in a certain length of the fiber becoming strained, and the optical path change along that length varies directly with the magnitude of that strain. Some of the scattered laser light 117 is back-scattered along the fiber 112 and is directed towards the optical receiver 103, and depending on the amount of time required for the scattered light 117 to reach the receiver and the phase of the scattered light 117 as determined at the receiver, the location and magnitude of the vibration or acoustics can be estimated with respect to time. DAS relies on interferometry using the reflected light to estimate the strain the fiber experiences. The amount of light that is reflected is relatively low because it is a subset of the scattered light 117. Consequently, and as evidenced by comparing FIGS. 1B and 10, Rayleigh scattering transmits less light back towards the optical receiver 103 than using the FBGs 114.

DAS accordingly uses Rayleigh scattering to estimate the magnitude, with respect to time, of the strain experienced by the fiber during an interrogation time window, which is a proxy for the magnitude of the vibration or acoustics emanating from the region of interest. In contrast, the embodiments described herein measure dynamic strain using interferometry resulting from laser light reflected by FBGs 114 that are added to the fiber 112 and that are designed to reflect significantly more of the light than is reflected as a result of Rayleigh scattering. This contrasts with an alternative use of FBGs 114 in which the center wavelengths of the FBGs 114 are monitored to detect any changes that may result to it in response to strain. In the depicted embodiments, groups of the FBGs 114 are located along the fiber 112. A typical FBG can have a reflectivity rating of between 0.1% and 5%. The use of FBG-based interferometry to measure dynamic strain offers several advantages over DAS, in terms of optical performance.

Referring now to FIG. 2, there is shown an optical interrogation system 10 that may be used to detect events in a pipeline, in accordance with an embodiment of the disclosure. FIG. 2 shows a pipeline 11 alongside which are provided first and second optical fibers 12 and 13. In some embodiments, each optical fiber 12,13 may comprise multiple individual interconnected lengths of optical fibers. In some embodiments, optical fibers 12,13 are attached directly to pipeline 11, whereas in other embodiments optical fibers 12,13 may be positioned within acoustic proximity of pipeline 11, meaning that optical fibers 12,13 are sufficiently close to pipeline 11 so as to detect acoustic, strain, or thermal energy originating from pipeline 11. Optical fibers 12,13 can be placed beside each other and, for example, may be covered with the same coating. Alternatively, optical fibers 12,13 may be placed in two adjacent microducts within the same conduit, or may be placed in two separate conduits which may be anywhere from directly adjacent to one another to up to five metres apart, for example. In some embodiments, optical fibers 12,13 may be separate portions of a single optical fiber looping back onto itself one or more times.

Each optical fiber 12,13 is optically coupled to an interrogator 14. Interrogator 14 is configured to interrogate optical fibers 12,13 using optical fiber interferometry, as described above. Interrogator 14 is communicatively coupled to a control module 15. Control module 15 comprises one or more processors and one or more memories comprising computer program code executable by the one or more processors and configured, when executed by the one or more processors, to cause the one or more processors to process phase data obtained by interrogator 14 from interferences between light pulses transmitted along optical fibers 12,13. In some embodiments, control module 15 may be comprised within interrogator 14 such that interrogator 14 may perform the functions of control module 15.

Each optical fiber 12,13 is divided into a number of channels or portions of optical fiber: optical fiber 12 is divided into channels 12a-12h, whereas optical fiber 13 is divided into channels 13a-13h. Each corresponding pair of channels are provided alongside a different portion of pipeline 11. In other words, pairs of channels correspond to like portions of pipeline 11. For example, channels 12a and 13a are positioned alongside a common portion of pipeline 11. In some embodiments, such as the embodiment shown in FIG. 3, pairs of channels may be offset from one another, such that only portions of pairs of channels correspond to like portions of pipeline 11. However, in such a case, for each pair of corresponding channels, a majority of the length of one of the channels is positioned alongside a majority of the length of the other channel.

In order to distinguish between different channels, interrogator 14 may employ techniques known in the art such as time division multiplexing (TDM) or wavelength division multiplexing (WDM), or a combination of both, as described above. For instance, in the context of WDM, different pulses having different wavelengths may be transmitted along each optical fiber 12,13. Each channel of optical fibers 12,13 may be provided with FBGs configured to reflect light having a certain wavelength. Depending on the wavelength of the reflections received from optical fibers 12,13, interrogator 14 may determine from which channel the reflections originated from.

There will now be described a method 200 of detecting leaks in a conduit (FIG. 4), in accordance with an embodiment of the disclosure. Method 200 represents merely one exemplary embodiment, and variations to the method may be made without departing from the scope of the disclosure. For example, the order of the operations may be modified, or additional operations may be added to the flow of operations. For instance, operations 210 and 220 may be performed simultaneously or near simultaneously.

At block 210, interrogator 14 obtains interferometric data from each of channels 12a-12h, by interrogating optical fiber 12 as described above. At block 220, interrogator 14 obtains interferometric data from each of channels 13a-13h, by interrogating optical fiber 13 as described above. The interferometric data is indicative of one or more of an acoustic signal, a strain signal, and a temperature signal. At block 230, for each optical fiber 12,13, control module 15 processes the interferometric data to extract parameter data from the interferometric data. The parameter data may comprise one or more of: a magnitude of the signal, a frequency centroid of the signal, a filtered baseline of the signal, a harmonic power of the signal, and a time-integrated spectrum flux of the signal. Suitable methods of parameter extraction are described in more detail in international patent publication WO 2017/147679, the contents of which is hereby incorporated by reference in its entirety.

Once the parameter data has been extracted, at block 240 control module 145 compares the parameter data obtained from optical fiber 12 with corresponding parameter data obtained from optical fiber 13. In particular, control module 15 compares the parameter data obtained from each channel of one of optical fibers 12,13 with corresponding parameter data obtained from each corresponding channel of the other optical fiber 12,13. Corresponding channels are those channels that are closest to one another. For example, in both the embodiments of FIGS. 2 and 3, control module 15 compares the parameter data obtained for channel 12a with that of channel 13a, 12b with 13b, etc. In some embodiments, control module 15 compares only specific channels, for example only channel 12e with 13e. Furthermore, control module 145 may compare parameter data for one or more different parameters. For example, control module 145 may compare parameter data wherein the specific parameter under consideration is acoustics, strain, or temperature.

There are various ways in which control module 15 may compare the parameter data. For example, the RMS magnitude of a parameter for one channel may be compared to the RMS magnitude of a parameter for the corresponding channel. For instance, the RMS magnitude of a strain signal for one channel may be compared to the RMS magnitude of a strain signal for the corresponding channel. Alternatively, a cross-correlation strength of the RMS magnitude of a parameter for one channel with the RMS magnitude of a parameter for the corresponding channel may be determined.

At block 250, control module 15 determines whether an event has occurred in a portion of pipeline 11 corresponding to a particular pair of channels. For example, if the comparison at block 240 indicates that the RMS magnitudes of the parameter or parameters under consideration are sufficiently close to one another (or if a cross-correlation strength of the parameter magnitudes is sufficiently high), then control module 15 may determine that an event, such as a leak, has occurred in the corresponding portion of pipeline 11. If on the other hand the comparison at block 240 indicates that the difference between the RMS magnitudes of the parameter or parameters under consideration is sufficiently high (or if a cross-correlation strength is sufficiently low), then control module 15 may determine that no event has occurred in the particular channel under consideration. In such a case, it is likely that the parameter data indicative of an event is due to system noise, and the associated channel has therefore identified a false positive.

Thus, by interrogating a second optical fiber positioned alongside the first optical fiber, the second optical fiber may be used as a confirmation optical fiber to validate or otherwise confirm the data obtained from the first optical fiber, to improve event detection and reduce the likelihood of false positives.

Methods of processing parameter data for determining whether an event has occurred are described in WO 2017/147679 (the contents of which is hereby incorporated by reference in its entirety), and may be used in connection with the present disclosure. For example, instead of comparing the RMS magnitudes of a parameter, or instead of determining a cross-correlation strength of the RMS magnitudes of a parameter, one or more of the event detection methods disclosed in WO 2017/147679 may be applied to the parameter data. Any detected events in the parameter data of a first optical fiber may then be compared to any detected events the parameter data of another optical fiber. The comparison may then be used to determine whether any of the detected events are indeed real events requiring investigation (e.g. leaks), or may be discounted as being due to system noise, for example.

For instance, if the event detection algorithms applied to the parameter data obtained from optical fiber 12 reveal a single event having a certain magnitude at a certain time, and if the event detection algorithms applied to the parameter data obtained from optical fiber 13 reveal an event having a similar magnitude at a similar time, then control module 15 may determine that a real event has occurred within pipeline 11. If on the other hand the detected events have different magnitudes, or occur at different times, then control module 15 may determine that no event has occurred.

While applying event detection techniques such as the ones described in WO 2017/147679 may be more computationally expensive as opposed to simply comparing the RMS magnitudes of parameters, or determining a cross-correlation strength of parameters, confidence in the results is likely to be higher when such event detection techniques are used.

When comparing data from one length of fiber to data from another length of fiber (for example when performing cross-correlation, comparing RMS magnitudes, or when comparing events as described above), it may be advantageous to divide the data into multiple frames or windows, for each length of optical fiber. Each window has a certain duration. Preferably, comparing data from one length of fiber to data from another length of fiber may comprise comparing the data for corresponding frames or windows, that is for pairs of windows that correspond to the same fixed length of time.

While the disclosure has been described in connection with specific embodiments, it is to be understood that the disclosure is not limited to these embodiments, and that alterations, modifications, and variations of these embodiments may be carried out by the skilled person without departing from the scope of the disclosure. For example, in some embodiments, more than two optical fibers may be used to interrogate the same conduit, for improved confidence in the detection of events and further reduction in the incidence of false positives. In such cases, a “majority rules” approach may be adopted for determining whether an event has actually occurred. For instance, in the case of two optical fibers confirming that an event has occurred, but a third optical fiber indicating no event has occurred, the result of the third optical fiber may be discarded.

It is furthermore contemplated that any part of any aspect or embodiment discussed in this specification can be implemented or combined with any part of any other aspect or embodiment discussed in this specification.

1. A method of detecting events in a conduit, comprising:
interrogating a first length of optical fiber, positioned alongside the conduit, to obtain interferometric data from the first length of optical fiber;
interrogating a second length of optical fiber, positioned alongside the conduit, to obtain interferometric data from the second length of optical fiber;
comparing the interferometric data obtained from the first length of optical fiber with the interferometric data obtained from the second length of optical fiber; and
determining, based on the comparison, whether an event has occurred in the conduit.

2. The method of claim 1, wherein:
interrogating the first length of optical fiber comprises obtaining interferometric data from each of multiple channels of the first length of optical fiber, each channel comprising a portion of the first length of optical fiber;
interrogating the second length of optical fiber comprises obtaining interferometric data from each of multiple channels of the second length of optical fiber, each channel comprising a portion of the second length of optical fiber; and
comparing the interferometric data comprises, for at least a first channel of the first length of optical fiber and a corresponding second channel of the second length of optical fiber, comparing their respective interferometric data, wherein, from among the channels of the second length of optical fiber, the second channel is the channel closest to the first channel.

3. The method of claim 1, wherein the first and second lengths of optical fiber are positioned within five meters of one another.

4. The method of claim 1, wherein each channel of one of the lengths of optical fiber is positioned alongside a corresponding channel of the other length of optical fiber.

5. The method of claim 1, wherein interrogating the lengths of optical fiber comprises:
using an optical fiber interrogator to:
transmit one or more light pulses along each of the first and second lengths of optical fiber; and
receive reflections of the one or more light pulses from each of the first and second lengths of optical fiber; and
obtaining the interferometric data from interferences between the reflections.

6. The method of claim 1, wherein the conduit comprises a pipeline or a wellbore.

7. The method of claim 1, wherein comparing the interferometric data comprises:
for each of the lengths of optical fiber, extracting parameter data from the interferometric data obtained from the length of optical fiber; and
comparing the parameter data obtained from the first length of optical fiber with the parameter data obtained from the second length of optical fiber.

8. The method of claim 7, wherein determining whether an event has occurred comprises determining whether a difference between a magnitude of the parameter data obtained from the first length of optical fiber and a magnitude of the parameter data obtained from the second length of optical fiber is less than a preset threshold.

9. The method of claim 7, wherein determining whether an event has occurred comprises determining whether a cross-correlation strength of the parameter data obtained from the first length of optical fiber with the parameter data obtained from the second length of optical fiber is greater than a preset threshold.

10. The method of claim 1, wherein the first length of optical fiber is closer to the conduit than the second length of optical fiber.

11. The method of claim 1, wherein the interferometric data comprises one or more of acoustic data, strain data, and temperature data.

12. The method of claim 1, wherein the interferometric data is indicative of one or more of an acoustic signal, a strain signal, and a temperature signal, and wherein comparing the interferometric data comprises:
for each of the lengths of optical fiber, extracting parameter data from the interferometric data obtained from the length of optical fiber, wherein the parameter data comprises one or more of a frequency centroid of the signal, a filtered baseline of the signal, a harmonic power of the signal, and a time-integrated spectrum flux of the signal;
determining from the extracted parameter data whether a potential event has occurred in the conduit; and
comparing a potential event obtained from the first length of optical fiber with a potential event obtained from the second length of optical fiber to thereby determine, based on the comparison, whether an event has occurred in the conduit.

13. A system for detecting events in a conduit, comprising:
a conduit;
first and second lengths of optical fiber positioned alongside the conduit;
an optical fiber interrogator configured to:
interrogate the first length of optical fiber so as to obtain interferometric data therefrom; and
interrogate the second length of optical fiber so as to obtain interferometric data therefrom; and
one or more processors communicative with a memory having stored thereon computer program code configured when executed by the one or more processors to cause the one or more processors to perform a method comprising:
comparing the interferometric data obtained from the first length of optical fiber with the interferometric data obtained from the second length of optical fiber; and
determining, based on the comparison, whether an event has occurred in the conduit.

14. A computer-readable medium having stored thereon computer program code configured when executed by one or more processors to cause the one or more processors to perform a method comprising:
obtaining interferometric data from a first length of length of optical fiber, wherein the first length of length of optical fiber is positioned alongside a conduit;
obtaining interferometric data from a second length of optical fiber, wherein the second length of optical fiber is positioned alongside the conduit;
comparing the interferometric data obtained from the first length of optical fiber with the interferometric data obtained from the second length of optical fiber; and
determining, based on the comparison, whether an event has occurred in the conduit.
